(19) United States
(12) Patent Application Publication
(10) Pub. No.: US 2024/0193476 A1
(43) Pub. Date: Jun. 13, 2024

(54) SYSTEM FOR ANALYZING EXPERIMENTAL DATA OF SCIENTIFIC EXPERIMENTAL DEVICE AND METHOD OF THE SAME

(71) Applicant: Aayon JEONG, Pohang-si (KR)

(72) Inventor: Aayon JEONG, Pohang-si (KR)

(21) Appl. No.: 18/444,405

(22) Filed: Feb. 16, 2024

Related U.S. Application Data
(63) Continuation of application No. PCT/KR2022/011853, filed on Aug. 9, 2022.

(30) Foreign Application Priority Data
Oct. 26, 2021 (KR) 10-2021-0143291

(51) Int. Cl. G06N 20/00

(52) U.S. Cl. CPC G06N 20/00

(57) ABSTRACT

According to an embodiment of the present invention, the scientific experimental device experiment data analysis system, collects and analyzes experimental data from the scientific experimental device through a network, provides the experimental report generated as a result of the analysis, wherein experimental report can be view based on a web accessed through a user terminal or mobile app, and includes analysis server providing experiment data collection function, data analysis and experimental report generation function, and experimental report inquiry and editing service function.

### CROSS-REFERENCE TO RELATED APPLICATIONS

This application is a bypass continuation of International Application No. PCT/KR2022/011853, filed on Aug. 9, 2022, which is based on and claims priority to Korean Patent Application No. 10-2021-0143291, filed on Oct. 26, 2021, in the Korean Intellectual Property Office, the disclosures of which are incorporated by reference herein in their entireties.

### BACKGROUND

### 1. Field

The present invention is related to a system and method for analyzing experimental data from a scientific experimental device, and more specifically, to collect and analyze experimental data from a scientific experimental device to generate an experimental report, and to provide various additional services for the experiment results.

### 2. Description of Related Art

A variety of scientific experimental devices are used for educational purposes in a school, but it is inconvenient to write each experiment result or experimental report by hand after a scientific experimental, and it is difficult to edit and revise systematically and efficiently, resulting in inefficient teaching between educators and students.

Therefore, in order to solve the above-mentioned problem, a system is designed to systematically collect and manage data on scientific experimental devices used in schools, analyze the data, and efficiently provide it in the form of a desired report. There is a need to establish a comprehensive and comprehensive scientific experimental device experiment data analysis system and method.

### SUMMARY

The purpose of the present invention is to provide an of scientific experimental device experiment data analysis system and method for collecting and analyzing experimental data from scientific experimental devices, generating experimental reports, and providing various additional services for experiment results.

The scientific experimental device experiment data analysis system according to an embodiment of the present invention, collects and analyzes experimental data from the scientific experimental device through a network, provides the experimental report generated as a result of the analysis, wherein experimental report can be view based on a web accessed through a user terminal or mobile app, and includes analysis server providing experiment data collection function, data analysis and experimental report generation function, and experimental report inquiry and editing service function.

The analysis server is characterized in that recognizes patterns for experimental elements by period, by device, or by experiment, for a plurality of experimental data collected for the scientific experimental device, and calculates statistical graphs or tables using data mining and logistic regression model.

The analysis server includes a collection unit that collects experimental data from the scientific experimental device through a network, an analysis unit that analyzes the experimental data collected through the collection unit and extracts necessary experimental elements to generate an experimental report, and a report management unit that collects the experimental elements analyzed and extracted by the analysis unit and generates an experimental report on the experiment results.

The scientific experimental device is characterized as a falling test device for measuring the falling time for a steel ball to reach its target point when dropped.

The experimental report is characterized in that includes the experiment title, summary of experiment contents, specific description of the experiment, comparative experiment examples, and tables or graphs.

The analysis server further includes learning prediction unit, wherein the learning prediction unit uses an artificial intelligence-based prediction model based on collected experimental data or sensing information to derive the effect of the experiment result and/or predict the error of the sensing unit based on the tolerance.

In the method of analyzing experimental data of a scientific experimental device using the analysis server according to an embodiment of the present invention, collecting, by the analysis server, experimental data of the scientific experimental device to generate experiment results and an experimental report, analyzing and extracting, by the analysis server, experimental elements necessary for generating an experimental report from the collected experimental data, generating, by the analysis server, an experimental report with analysis and extraction results based on the request of the user terminal, wherein the experimental report includes graph and/or table generated based on a selecting a mathematical statistical model and a fitting process of and setting fitting factors corresponding to quantitative values for the X and Y axes, and providing editing function for a text included in the experimental report and/or editing and final confirmation function for the completed experimental report, to the user terminal.

The present invention has the advantage of collecting experimental data from various scientific experimental devices and generating various forms of experimental reports based on the collected experimental data, and providing fitting and additional functions to produce customized graphs or diagrams, increasing user convenience and efficiently creating experimental reports, and furthermore, performing systematic and comprehensive experimental education.

In addition, when analyzing experimental data, it is possible to receive remote help on the network through the user terminal possessed by the expert as needed to analyze experimental data for professional report writing, and it is possible to efficiently proceed with the experimental process and experimental results based on web-based and mobile apps, and it has the advantage of providing systematic management of scientific experimentals and user-friendly functions to generate interest, thereby improving educational effectiveness and helping to foster young scientists.

### BRIEF DESCRIPTION OF THE DRAWINGS

FIG. 1 is a block diagram showing the configuration of an experimental data analysis system of the scientific experimental device according to an embodiment of the present invention.

FIG. 2 is a block diagram showing in detail the internal configuration of an experimental data analysis system of the scientific experimental device of FIG. 1.

FIG. 3 is a flowchart of a method for analyzing experimental data from a scientific experimental device according to an embodiment of the present invention.

FIG. 4 is a diagram showing an example of a fall test device, a scientific experimental device.

FIG. 5 is a diagram showing an example of the main page for analyzing and viewing scientific experimental data as a web-based or mobile app-based service.

FIG. 6 is a diagram showing an exemplary screen for viewing my experiment list using a web-based or mobile app-based service.

FIG. 7 is a diagram showing an example of a detailed content inquiry page of my experiment list as a web-based or mobile app-based service.

FIG. 8 is a diagram showing an example of a scientific experimental data registration page as a web-based or mobile app-based service.

FIG. 9 is a diagram showing an example of a scientific experimental data analysis page as a web-based or mobile app-based service.

FIG. 10 is a diagram showing an example of an experimental report creation screen using a web-based or mobile app-based service.

### DETAILED DESCRIPTION

Hereinafter, specific embodiments of the present invention will be described in detail with reference to the drawings. However, the idea of the present invention is not limited to the embodiments shown, and those skilled in the art who understand the idea of the present invention will be able to easily propose other inventions or other embodiments that are regressive to the idea of the present invention by adding, changing, deleting, etc. other components within the scope of the same idea, which are also included within the scope of the invention. In addition, components having the same function within the scope of the same idea that appear in the drawings of each embodiment are described using the same reference numerals.

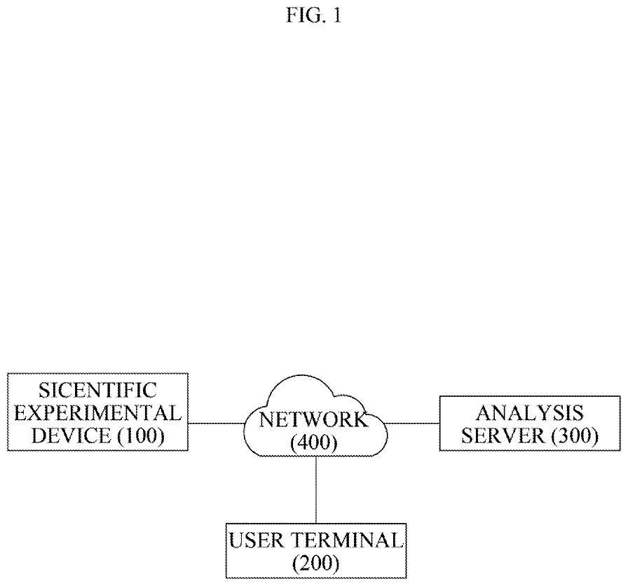

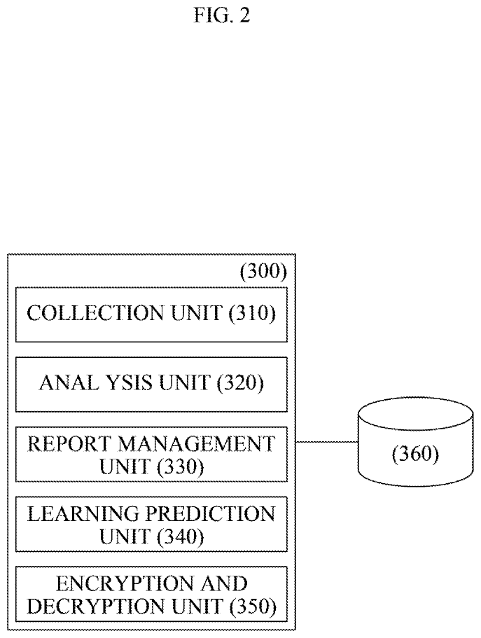

FIG. 1 is a block diagram showing the configuration of the experimental data analysis system of the scientific experimental device 100 according to an embodiment of the present invention. FIG. 2 is a block diagram showing in detail the internal configuration of the experimental data analysis system of scientific experimental device 100 of FIG. 1.

Referring to FIG. 1, the experimental data analysis system of the scientific experimental device 100 may include an analysis server 300 that collects and analyzes experimental data from the scientific experimental device 100 through a network 400, and provides an experimental report generated as the analysis' result based on a web-based or mobile application accessible through a user terminal 200.

The analysis server 300 may include an API (application programming interface) for interfacing with an experiment management app installed and executed on a separate user terminal 200 for providing an experimental report generation and inquiry service based on a mobile app, and may provide overall services such as an experiment data collection function, an analysis and report generation function, and an experimental report inquiry and editing service function through the experiment management app as a web-based service.

In order to perform the above-described functions, the analysis server 300 may include a collection unit 310, an analysis unit 320, a report management unit 330, a learning prediction unit 340, and an arm. It further includes a decryption unit 350 and a database 360.

The collection unit 310 may collect experimental data from the scientific experimental device 100 through the network 400.

In addition to experimental data, the collection unit 310 may additionally collect device unique identification codes or user terminal 200 unique codes for identifying each scientific experimental device 100, and sensing information sensed by the sensing unit 120, as needed.

Here, the scientific experimental device 100 may be various types of scientific experimental tools, and it is especially desirable to be a device implemented to enable data communication through the network 400.

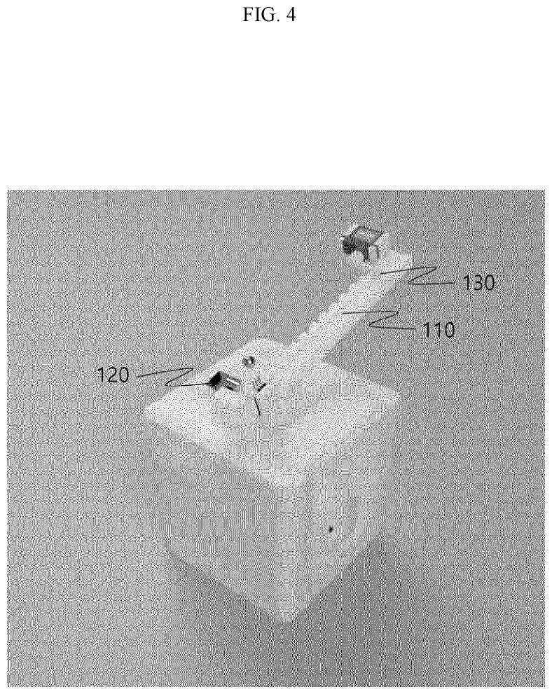

A specific example of the scientific experimental device 100 is shown in FIG. 4, which is a falling experimental device, which is an example of the scientific experimental device 100.

In order to generate experimental data for generating a specifically required experimental report, the falling experimental device may include a inclined surface 110 having an angle adjustable via a servo motor and a ramp from which the iron ball can fall, a sensing unit 120 for measuring the fall time of the iron ball to reach a target point when falling, a control unit that generates experimental data based on the fall time and transmits it to the analysis server 300 via a communication unit, a communication unit, and a display portion having various display functions.

In addition, the falling experimental device may have a motor-controlled opening and closing door 130 at the top of the inclined surface 110 to block the starting point of the iron ball before falling, and a sensing unit 120 including an illumination sensor and a laser module at the bottom of the inclined surface 110.

Specifically describing the principle of measuring the fall time of the drop test apparatus based on the configuration described above, the sensing unit 120 includes a laser module and an illuminance sensor or a light sensor, and the laser module emits a laser to the light receiver of the illuminance sensor located at the bottom of the ramp of the inclined surface 110, and starts a timer for the fall of the iron ball, ending the timer at a moment when the metal ball dropped down the ramp blocks the laser across the bottom of the ramp, e.g., no laser is input to the light receiver, thereby measuring the timer interval to calculate a fall time, and the control unit may generate experimental data including at least one experimental fall time.

Furthermore, experimental data may include not only data on necessary experimental elements that occur during an experiment such as drop time, but also documents containing experimental materials, experimental composition, and experimental method, or photographic images, videos of the experimental site, etc. For such images or videos, the analysis server 300 may recognize the text using optical character recognition (OCR) and automatically extract text information about the experiment title and experiment contents to be included in the experimental report.

The above falling experimental device is only an example of the scientific experimental device 100, and other experimental apparatus may be included, as long as it is capable of generating experimental data and transmitting it to the analysis server 300 via the network 400.

The analysis unit 320 may analyze the experimental data collected through the collection unit 310 and extract the necessary experimental elements to generate a report.

In particular, data mining, logistic regression models, and the like may be utilized to recognize patterns for various experimental factors by period, device, or experiment, and to produce statistical graphs, tables, and the like, based on a plurality of experimental data collected for one scientific experimental device 100.

In other words, the task of graphing or tabularizing quantitative figures using various mathematical and statistical models for the collected experimental data through the fitting factors set for the X axis, and Y axis is called fitting.

In this way, the fitting operation may produce statistical graphs or tables for reports, with the advantage that the graphs or tables can be customized by the user, who can set the fitting factors themselves.

The report management unit 330 may collect the experimental elements analyzed and extracted by the analysis unit 320 and generate an experimental report on the experiment results of a certain standard.

The experimental report forms may be generated to correspond to for each school's specific format, and may include a title, a summary of the experiment, a detailed description of the experiment, examples of comparisons, tables, graphs, and photos or videos of the experiment site.

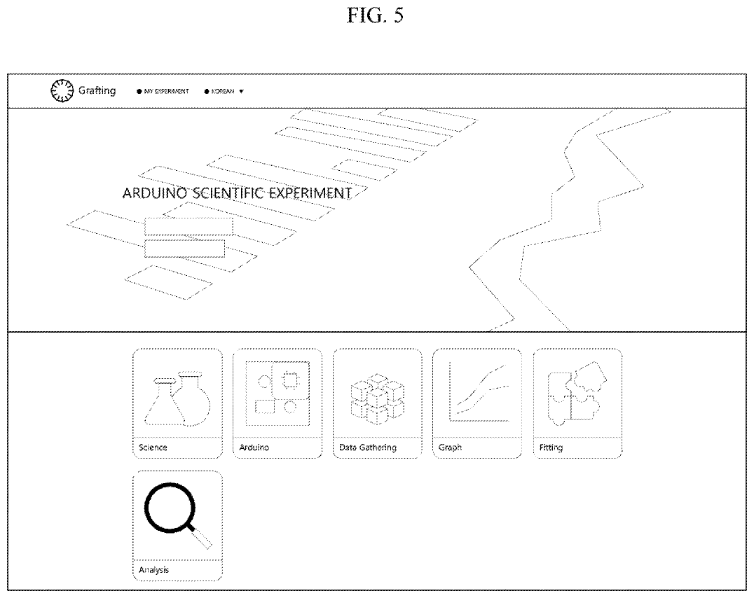

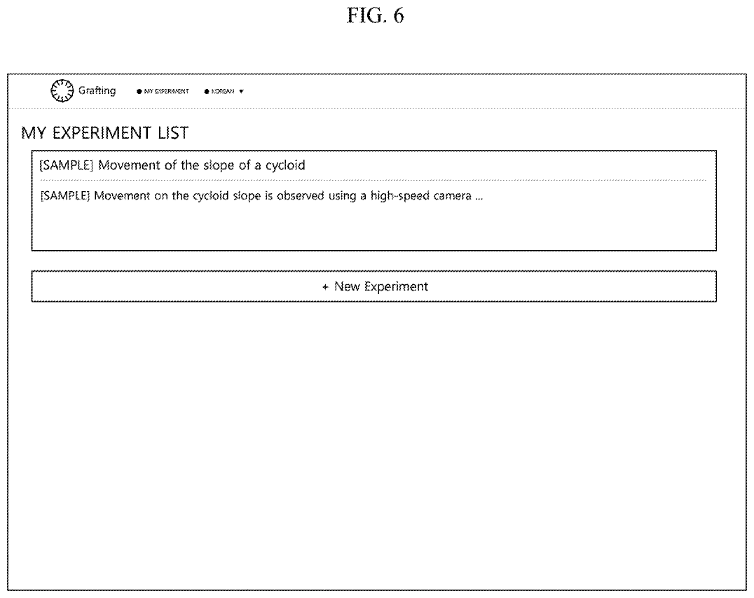

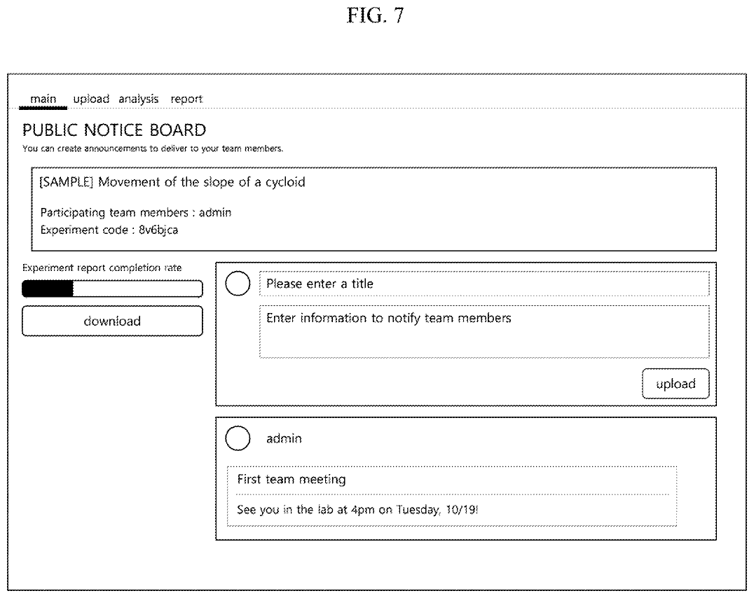

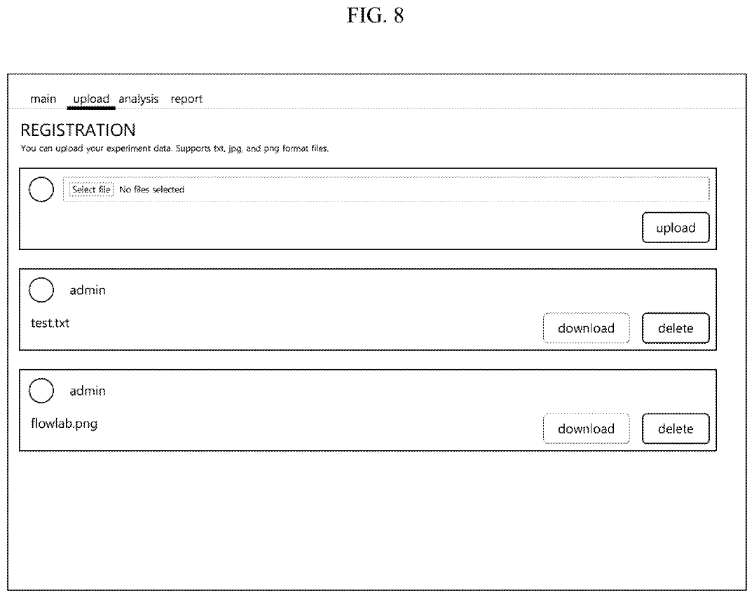

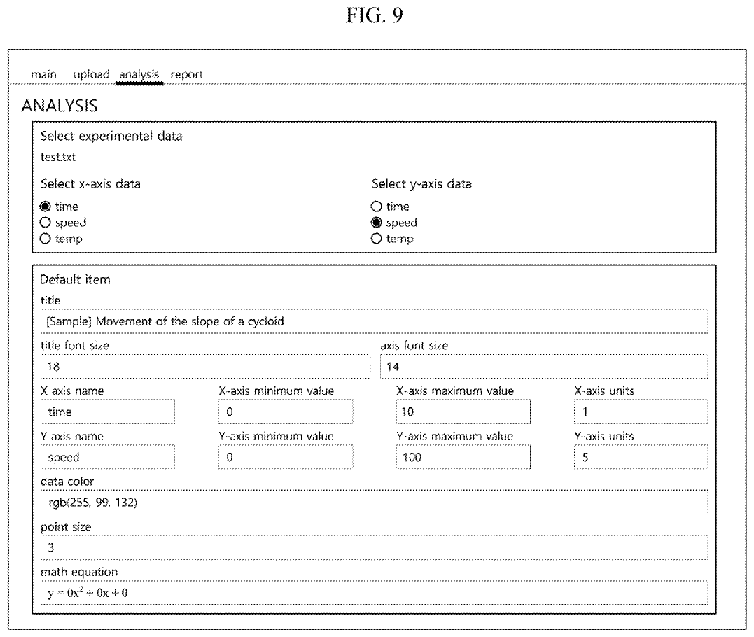

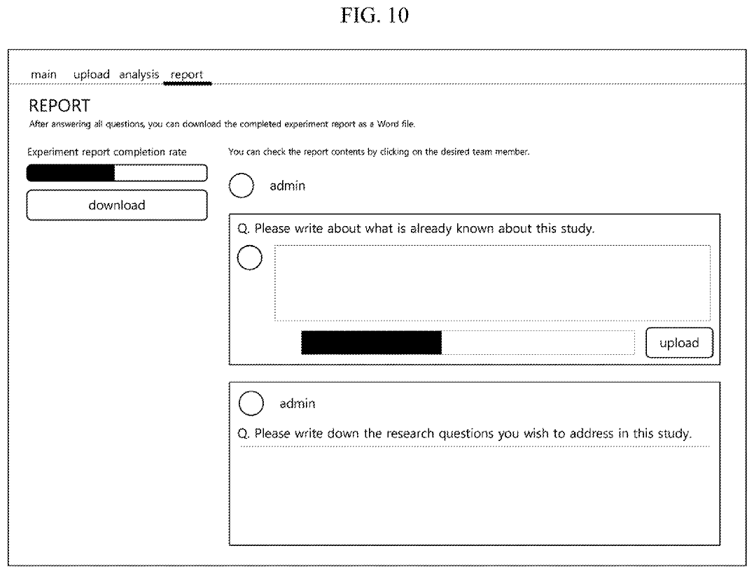

In addition, various inquiry and registration services may be provided based on the collected experiment data. For example, FIG. 5 is a diagram showing an example of the main page for analyzing and viewing scientific experimental data as a web-based or mobile app-based service. FIG. 6 is a diagram showing an exemplary screen for viewing my experiment list using a web-based or mobile app-based service. FIG. 7 is a diagram showing an example of a detailed content inquiry page of my experiment list as a web-based or mobile app-based service. FIG. 8 is a diagram showing an example of a scientific experimental data registration page as a web-based or mobile app-based service. FIG. 9 is a diagram showing an example of a scientific experimental data analysis page as a web-based or mobile app-based service. FIG. 10 is a diagram showing an example of an experimental report creation screen using a web-based or mobile app-based service.

In particular, on the scientific experimental data analysis page in FIG. 9, users can directly upload experimental titles and experimental data, select a fitting function (mathematical statistical model, etc.) or fitting factor to directly determine the experimental result graph calculated based on the experimental data, check the calculated graph through the preview of the graph, and provide various additional services to download the graph, which has the advantage of increasing user convenience.

In addition, the experiment manual including the experiment video may be viewed through the experiment management app, and the scientific experimental device 100 may be assembled in a DIY form if necessary for education, and a screen for viewing the experiment apparatus assembly video may be provided for this purpose.

In addition, by providing a screen for creating an experimental diary and a screen for viewing the experimental result analysis tool, users may directly select various mathematical and statistical models and directly set the fitting parameters to be reflected in the graph calculation, allowing users to derive customized experimental result graphs.

In addition, FIG. 10 is a diagram showing an example of an experimental report creation screen using a web-based or mobile app-based service.

As such, the present invention has the advantage of collecting experimental data on experimental results, generating experimental reports on experimental results, and providing additional other services, so that users may receive various services for experiments, increasing convenience and effectively deriving results for experiments.

In addition, all of the above-described examples may provide the same functions as web-based services and mobile app-based services, and users may access and receive the services in the form of their choice.

The learning prediction part 340 may utilize an artificial intelligence-based prediction model based on the collected experimental data or sensing information to derive an effect of the experimental result based on a reference value or to predict an error of the sensing unit 120 based on a tolerance.

The prediction model may be a prediction model based on an Artificial Neural Network, a Radial Basis Function (RBF) neural network, a Support Vector Machine (SVM) algorithm, or the like.

Furthermore, big data of sensing information, prediction results, and experimental data may be used to generate statistical data on whether a sensor is expected to fail or be abnormal in the future, or the expected effect of an experimental result.

In other words, sensing information provided by the collection unit 310 may be used as an input to a prediction model, which is an artificial intelligence machine learning model, and a prediction result that predicts a normal or abnormal condition based on a tolerance based on the condition of the sensing unit 120 provided in the scientific experimental device 100 may be calculated.

In addition, in the case of an abnormality, a warning alarm may be sent to the user terminal 200 to help the user determine whether the sensing unit 120 of the scientific experimental device 100 is malfunctioning and utilize it for maintenance.

In addition, predicting the expected effect of an experimental result is a prediction of whether the experiment is a normal experiment, e.g., an effective experiment. It may be predicted based on a reference value for the normal range of the experimental data.

In addition, as the experimental data accumulates, statistical data on the expected effects and normal range errors of future experimental results using the SVM may be generated and provided for viewing on the user terminal 200, and the user can also use it as a reference for whether the experiment is performed normally or how the experiment should be performed, which can be helpful in terms of education.

The decryption unit 350 may perform lightweight encryption algorithms for data protection to prevent artificial manipulation or tampering of the collected experimental data.

Additionally, information (e.g., sensing information or experimental data) exchanged between the analysis server 300 and the user terminal 200 may be subject to data encryption/decryption techniques to protect the information from risks such as external hacking. More specifically, the analysis server 300 and the user terminal 200 are each given identification information that can prove their identity, and a lightweight cryptographic algorithm is performed that utilizes the identification information of the analysis server 300 and the user terminal 200 as a private key. Lightweight cryptographic algorithms are cryptographic techniques designed for implementation in limited environments such as smart devices such as the user terminal 200 of the present invention, and may use symmetric key cryptographic algorithms such as HIGHT (high security and light weight), LEA (lightweight encryption), and LSH (lightweight secure hash), which are hash functions.

By using these lightweight cryptographic algorithms to encrypt/decrypt sensing information, it is possible to prevent external leakage of such data or illegal control by external hacking. Lightweight cryptographic algorithms preferably use lightweight hash functions that are suitable for such embedded computing environments.

A lightweight hash function is a relatively low-computation hash function (one-way function) designed to ensure the integrity of transmitted or received data while excluding some computationally expensive features of standard cryptographic hash algorithms such as SHA-3.

More specifically, among these lightweight hash functions, it is preferable to use the Sponge algorithm, which allows for permutation of unkeyed data.

More specifically, a sponge is implemented to take an original message (in this case, the original data of a randomized key), pad it to a certain size (padding), split it into multiple pieces with a certain base size known only to the generator of the key (e.g., the original message split into specific bit sizes), and then exchange randomized data at the end of the multiple pieces of data (the split original message) utilizing multiple update functions, and decrypt it on the other side utilizing the already known base size.

In other words, such a lightweight hash function can be utilized to ensure the security of the hash function while requiring relatively less computing power than the use of a typical hash function, resulting in lower power consumption and longer life of the user terminal 200.

The database 360 may store collected experimental data, sensing information, statistical information, communication event information, and the like for information storage and management.

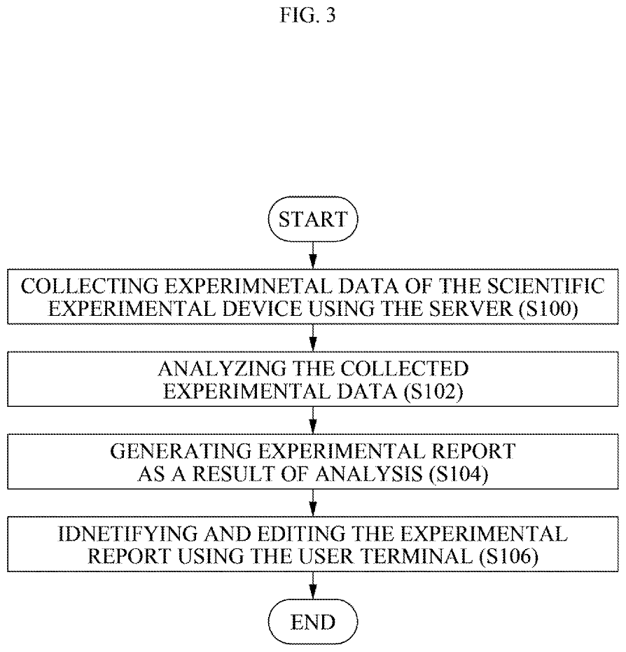

FIG. 3 is a flowchart of a method for analyzing experimental data of the scientific experimental device 100 according to one embodiment of the present invention.

First, the analysis server 300 collects experimental data of the scientific experimental device 100 (S100) to generate experimental results and experimental reports.

The collected experimental data may be analyzed and extracted for experimental elements necessary to generate an experimental report (S102).

The user may generate an experimental report as a result of the analysis and extraction, and the graph to be included in the experimental report can be calculated in a desired graph or table form through a fitting process of selecting a mathematical statistical model and setting a fitting factor (S104).

The user terminal 200 may edit text or the like included in the experimental report, or finalize or edit the completed experimental report (S106).

In the present specification, a “terminal” may be a wireless communication device with guaranteed portability and mobility, for example, any kind of handheld-based wireless communication device such as a smartphone, tablet PC, or laptop, etc. It is also possible for the “terminal” to be a wired communication device, such as a PC, that can connect to other terminals or servers, etc. via the network 400. Furthermore, the network 400 refers to a connection structure in which information can be exchanged between respective nodes such as terminals and servers, and includes a local area network (LAN), a wide area network (WAN), the Internet (WWW), a wired or wireless data communication network, a telephone network, a wired or wireless television communication network, etc.

Examples of wireless data communication networks include 3G, 4G, 5G, 3GPP (3rd Generation Partnership Project), LTE (Long Term Evolution), WIMAX (World Interoperability for Microwave Access), Wi-Fi, Bluetooth communication, and infrared. It includes, but is not limited to, communication, ultrasonic communication, Visible Light Communication (VLC), LiFi, etc.

What is claimed is:

1. System for analyzing scientific experimental data of a scientific experimental device, including:
an analyzing server configured to:
collect, through a network, experimental data from the scientific experimental device,
analyze the experimental data,
provide an experimental report generated based on the analysis of the experimental data such that a user terminal checks the experimental report based on web or mobile application, and
provide a function for editing the experimental report.

2. The system of the claim 1, wherein the analyzing server is further configured to:
recognize a pattern of experimental elements by period, by device, or by experiment based on the collected experimental data from the scientific experimental device,
generate a table or a statistical graph based on the pattern, a data mining, and logistic regression model.

3. The system of the claim 2, wherein the analyzing server comprises:
a collection unit configured to collect, through a network, experimental data from the scientific experimental device,
an analyzing unit configured to extract the experimental elements required to generate the experimental report, and
a report management unit configured to generate the experimental report based on the experimental data and the extracted elements of experiment.

4. The system of the claim 3, wherein the scientific experimental device is a drop test device configured to measure a falling time for a steel ball to reach target point when the steel ball falls.

5. The system of the claim 3, wherein the experimental report includes the experiment title, summary of experiment contents, specific description of the experiment, comparative experiment examples, and tables or graphs.

6. The system of the claim 5, wherein the analyzing server comprises:
a learning prediction unit configured to predict an error of the sensing unit based on tolerance using an artificial intelligence-based prediction model based on the collected experimental data or sensing information.

7. Operation method of system for analyzing scientific experimental data of a scientific experimental device, including:
collecting, through a network by an analyzing server, experimental data from the scientific experimental device;
analyzing and extracting, by the analyzing server, experimental elements necessary for generating an experimental report based on the experimental data;
based on a request of a user terminal, generating, by the analyzing server, an experimental report based on an analysis of the experimental elements, wherein the experimental report includes graph or table based on selecting a mathematical statistical model and a fitting process that sets fitting factors corresponding to quantitative values for the X axis and Y axis; and
providing, by the user terminal server, a function for editing texts included in the experimental report, and a function of confirming the experimental report to the user terminal.
